(19) United States
(12) Patent Application Publication
(10) Pub. No.: US 2018/0086191 A1
(43) Pub. Date: Mar. 29, 2018

(54) DUAL-MODE AUTOMOBILE PROTECTIVE COVER DEVICE

(71) Applicant: WAIYING WONG, Sheung Shui N.T. (HK)

(72) Inventor: WEIQUAN HUANG, Zhejiang (CN)

(73) Assignee: WAIYING WONG, Sheung Shui N.T. (HK)

(21) Appl. No.: 15/561,692

(22) PCT Filed: Feb. 24, 2016
(86) PCT No.: PCT/CN2016/074432

§ 371 Date: Sep. 26, 2017

(30) Foreign Application Priority Data
Mar. 27, 2015 (CN) 201520177673.4

(51) Int. Cl. B60J 11/02

(52) U.S. Cl. CPC B60J 11/02

(57) ABSTRACT

A dual-mode automobile protective cover device comprises an outer housing provided with a rotary shaft therein, wherein, the outer housing comprises of three parts: a cabin, a cabin cover A and a cabin cover B. The cabin is detachably or fixedly connected to the cabin cover A and the cabin cover B. A wire slot is provided on a wall of the cabin, and the wire slot has an electric wire therein. A control box and a motor box are respectively provided at two ends of the outer housing. As the duel-mode automobile protective cover device can operate either under electric power or manual operation, it solves the problem that once electricity is cut off, the protective cover cannot be unfolded or retracted quickly.

### CROSS REFERENCE TO RELATED APPLICATION

This application claims the benefit of CN Patent Application No. 201520177673.4, filed Mar. 27, 2015, the disclosure of which is incorporated by claiming priority.

### FIELD OF THE INVENTION

The present disclosure relates to the field of automobile protective covers, and more particularly, to a dual-mode device for unfolding and retracting automobile protective cover.

### BACKGROUND OF THE INVENTION

At present there are mainly two types of automobile protective cover device in the market: the manual type and the electric type.

The manual type automobile protective cover device is of great inconvenience as it can only be actuated without electricity and by manual operation to unfold and retract the cover.

The electric type mainly automatically unfolds and retracts the protective cover which is fixed to a rotary shaft via the electricity-driven rotary shaft. If the power of the motor is cut off when the device is in operation, it will be very difficult to retract or unfold the protective cover.

The market has not seen an automobile protective cover device that can work both manually and electrically through easy and convenient operation.

### SUMMARY OF THE INVENTION

The present invention aims to provide a dual-mode automobile protective cover device that mainly works under electric power with manual operation as a back-up choice. It can be realized through the following technical solutions:

The dual-mode automobile protective cover device comprises an outer housing, in which a rotary shaft is fitly arranged, wherein, the outer housing comprises three parts: a cabin, a cabin cover A and a cabin cover B. The cabin is detachably or fixedly connected to the cabin cover A and the cabin is detachably or fixedly connected to the cabin cover B. A wire slot is provided on a wall of the cabin accordingly, and electric wires are buried therein. A control box and a motor box are respectively arranged at two ends of the outer housing, one end of the rotary shaft is fitly connected with the cabin cover B, and the other end of the rotary shaft is fitly connected with the motor box by passing through the cabin cover A. The motor box is detachably connected to the cabin cover A and the rotary shaft. The motor box is provided with a contact chip A, and the cabin cover A is provided with a contact chip B, one end of the electric wire is fitly connected with the contact chip B, and the other end of the electric wire is fitly connected with the control box. A rechargeable battery is configured within the control box, and a charge socket is arranged on the control box. The motor box can be replaced by a hand-operated rocker.

Preferably, a protective cover guard disc is provided at each of the two ends of the cabin.

Preferably, the motor box and the cabin cover A are connected by means of snap-fits, a snap-in slot is provided on the cabin cover A and a snap-fit is provided on the motor box, wherein the snap-fit is made up of a male part and a female part. The female part is cut with a groove, in which a sliding bar and a spring are configured; the male part, which is of Z shape, has a sliding slot in its front end, the sliding slot is in slide connection with the sliding bar, and a hook, which can be buckled with the snap-in slot, is arranged at the back end of the male part.

Preferably, the cabin cover A can be provided with two snap-in slots, and accordingly the motor box can be provided with two snap-fits.

Preferably, a contact chip A is provided on the control box, a contact chip B is provided on the cabin cover B, and the other end of the electric wire is fitly connected with the contact chip B.

Preferably, the control box and the cabin cover B are connected by means of a snap-fit, a snap-in slot is provided on the cabin cover B and a snap-fit is provided on the control box, wherein the snap-fit is made up of a male part and a female part. The female part has a groove, in which a sliding bar and a spring are arranged; the male part, which is of Z shape, has a sliding slot in its front end, the sliding slot is in slide connection with the sliding bar, and a hook that can be buckled with the snap-in slot is arranged at the back end of the male part.

Preferably, the cabin cover B can be provided with two snap-in slots, and accordingly the control box can be provided with two snap-fits.

Preferably, the control box is provided with a control button and an indicator light. Preferably, the cabin is provided with an anti-slide mat, the material of which comprises sponge.

Preferably, the invention can be operated remotely through a remote control.

Compared with the prior arts, the present invention has the following advantages:

Firstly, as the invention can operate under either electric power or manual operation, even if the electricity is cut off, the protective cover can still be retracted or unfolded quickly through manual operation. Secondly, with the male part and the female part under slide connection, it enables easy disassembling between a motor box cover and the cabin cover A as well as a control box cover and the cabin cover B.

### BRIEF DESCRIPTION OF THE DRAWINGS

FIG. 1 is a structural schematic diagram of the invention under the electricity-driven state;

FIG. 2 is a sectional diagram of the rear view of the invention;

FIG. 3 is a structural schematic diagram of the motor box and the cabin cover A of the invention;

FIG. 4 is a structural schematic diagram of the motor box and the snap-fit of the invention;

FIG. 5 is a structural schematic diagram of the control box and cabin cover B of the invention;

FIG. 6 is a structural schematic diagram of the control box and the snap-fit of the invention;

FIG. 7 is a structural schematic diagram of the snap-fit of the invention;

FIG. 8 is a structural schematic diagram of the invention under the manual-operated state;

FIG. 9 is a structural schematic diagram of the remote control for the invention.

Description of the reference numerals of the drawings: 1—motor box, 2—cabin cover A, 3—protective cover guard disc, 4—outer housing, 5—cabin, 6—anti-slide mat, 7—cabin cover B, 8—control box, 9—snap-fit, 10—wire slot, 11—rotary shaft, 12—contact chip A, 13—contact chip B, 14—snap-in slot, 15—male part, 16—female part, 17—hook, 18—sliding slot, 19—spring, 20—sliding bar, 21—hand-operated rocker, 22—groove, 23—remote control.

### DETAILED DESCRIPTION

The present disclosure is further described hereafter with reference to the drawings and embodiments; however, the present invention is not limited to the specifically disclosed embodiments.

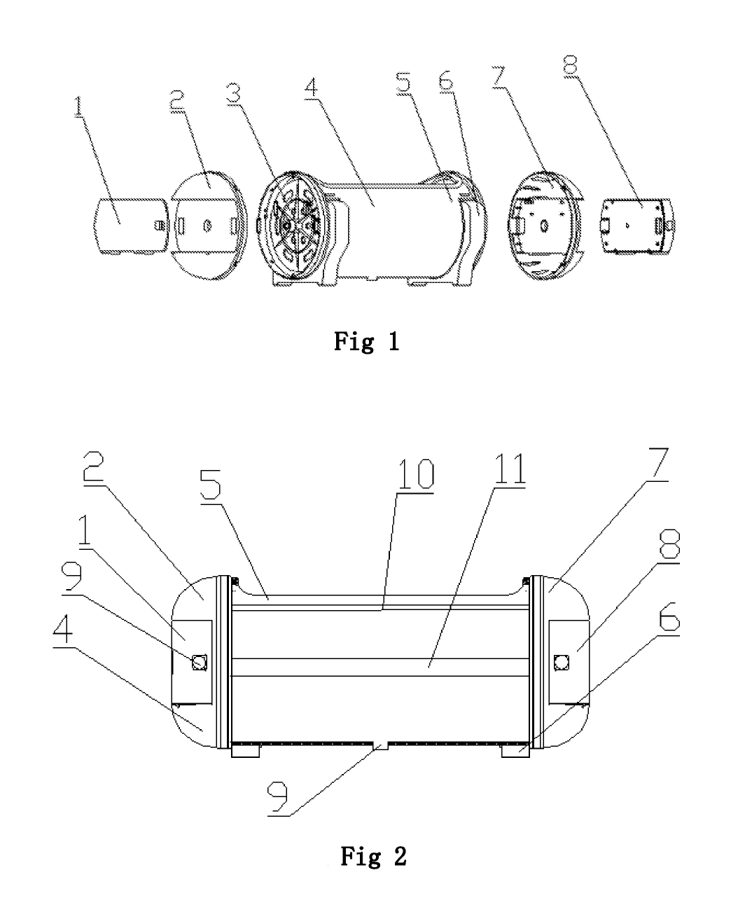

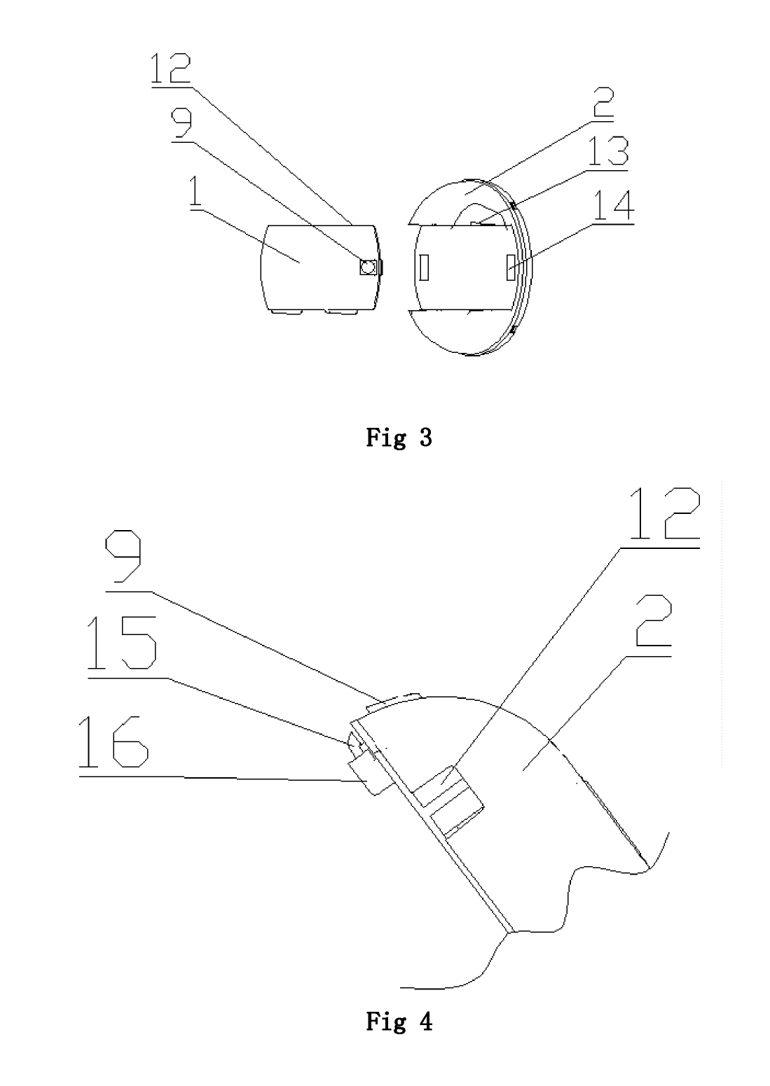

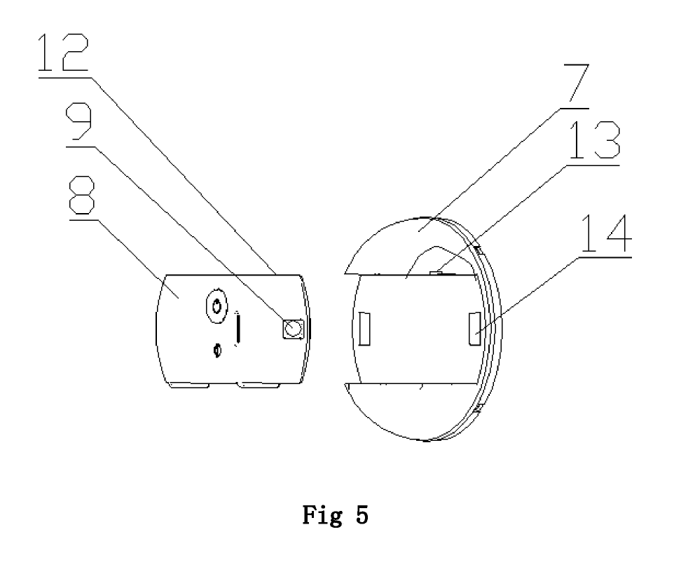

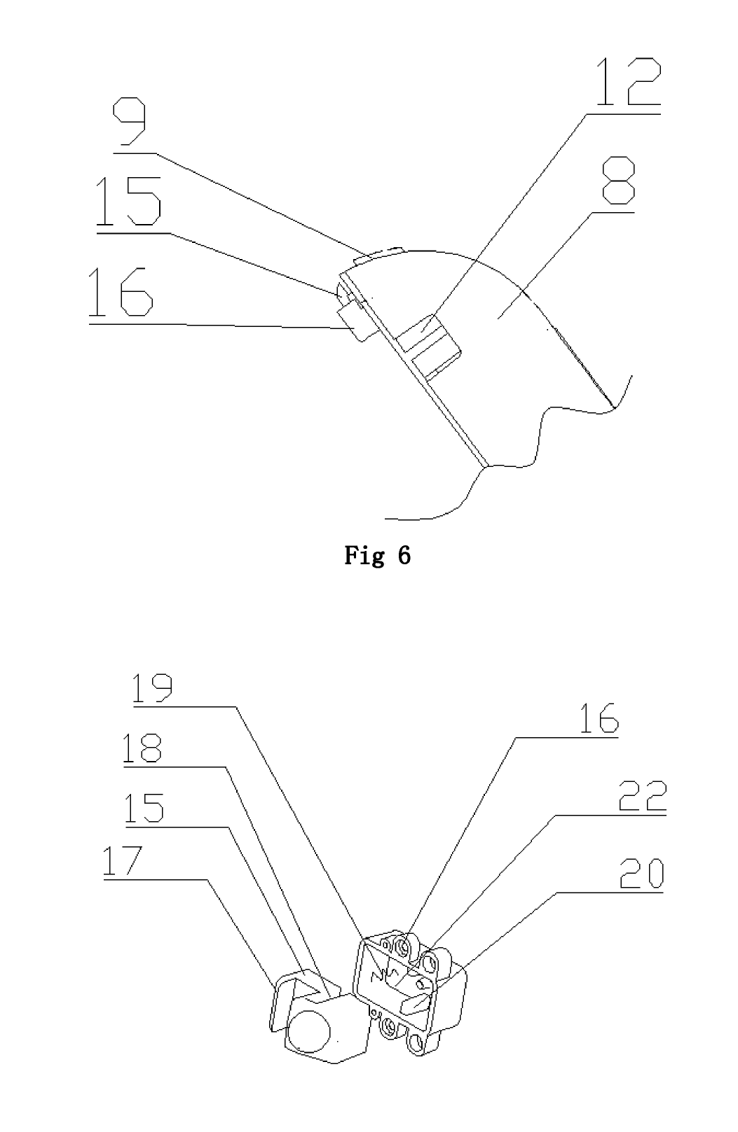

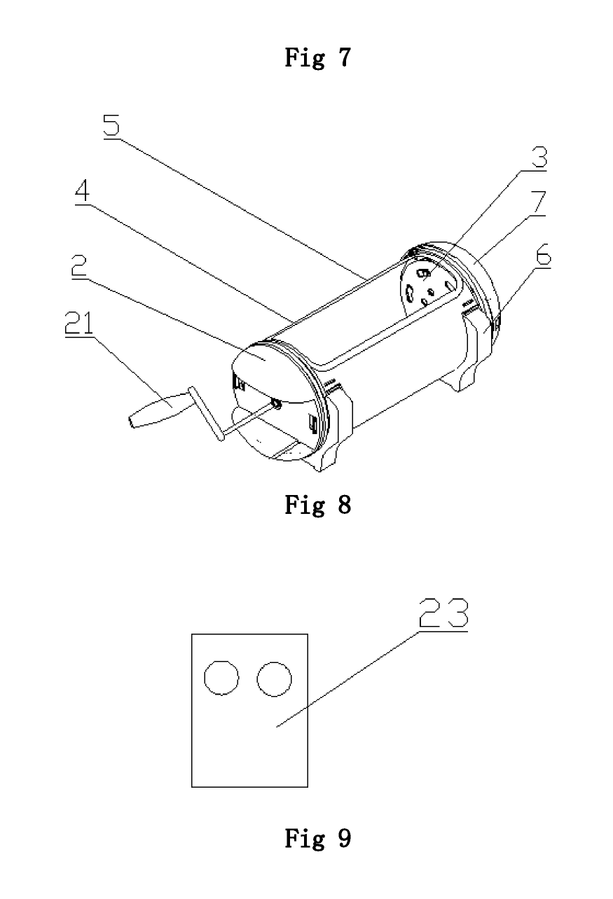

Referring to FIG. 1 to FIG. 5, the invention comprises an outer housing 4 provided with a rotary shaft 11 therein, and the outer housing 4 comprises three parts: a cabin 5, a cabin cover A 2 and a cabin cover B 7. The cabin 5 is detachably or fixedly connected with the cabin cover A 2 and is detachably or fixedly connected with the cabin cover B 7. Each of the two ends of the cabin 5 is provided with a protective cover guard disc 3, which prevents the protective cover from getting stuck in the cabin cover A2 or the cabin cover B7 in the process of unfolding or retracting. The cabin 5 is provided with an anti-slide mat 6, the material of which comprises sponge. A wire slot 10 is provided on a wall of the cabin 5, and the wire slot 10 has an electric wire therein. A control box 8 and a motor box 1 are respectively arranged at two ends of the outer housing 4, one end of the rotary shaft 11 is fitly connected with the cabin cover B 7, and the other end of the rotary shaft 11 is fitly connected with the motor box 1 after it passes through the cabin cover A 2. The motor box 1 is detachably connected with the cabin cover A 2 and the rotary shaft 11. The motor box 1 and the cabin cover A 2 are connected by means of a snap-fit 9, a snap-in slot 14 is provided on the cabin cover A and a snap-fit 9 is provided on the motor box 1. The amount of the snap-in slot 14 provided on the cabin cover A can be two, and accordingly the amount of the snap-fit 9 provided on the motor box 1 can be two. The snap-fit 9 is made up of a male part 15 and a female part 16. The female part 16 is cut with a groove 22, in which a sliding bar 20 and a spring 19 are arranged; the male part 15, which is of Z shape, is provided with a sliding slot 18 accordingly in its front end, the sliding slot 18 is in slide connection with the sliding bar 20, and a hook 17 that can be buckled with the snap-in slot is arranged at the back end of the male part 15. When the hook 17 clasps the snap-in slot 14, the motor box 1 is fixed firmly with the cabin cover A 2; by pushing the male part 15 inward, the hook 17 is separated from the snap-in slot 14, thus the connection between the motor box 1 and the cabin cover A 2 is unfastened. The motor box 1 can be replaced by a hand-operated rocker 21. The motor box 1 is provided with a contact chip A 12, the cabin cover A 2 is provided with a contact chip B 13, and one end of the electric wire is connected to the contact chip B 13, and the other end of the electric wire is connected to the control box 8. The control box 8 is provided with a contact chip A 12, and the cabin cover B 7 is provided with a contact chip B 13. The cabin cover B 7 can be provided with two snap-in slots 14 and the control box 8 can be provided with two snap-fits 9. The control box 8 and the cabin cover B 7 are connected in the same way as that of the motor box 1 and the cabin cover A. The control box 8 is provided with a control button and an indicator light. The invention can be operated from a distance through a remote control 23.

Lastly, it should be specified that the foregoing embodiments are merely used to explain the invention, but are not intended to make limits. Although the invention is described in detail with reference to the preferred embodiments, those skilled in the art should understand that any fine modification or equivalent replacement made to the above embodiments according to the spirit and technical substance of the invention shall all fall within the protection scope of the invention.

What is claimed is:

1. A dual-mode automobile protective cover device comprises an outer housing (4) in which a rotary shaft (11) is arranged, wherein the outer housing (4) comprises three parts: a cabin (5), a cabin cover A (2) and a cabin cover B (7), the cabin (5) is detachably or fixedly connected to the cabin cover A (2) and the cabin (5) is detachably or fixedly connected to the cabin cover B (7); a wire slot (10) is provided on a wall of the cabin (5), and the wire slot (10) has an electric wire buried therein; a control box (8) and a motor box (1) are respectively arranged at two ends of the outer housing (4), one end of the rotary shaft (11) is fitly connected with the cabin cover B (7), and the other end of the rotary shaft (11) is fitly connected with the motor box (1) by passing through the cabin cover A (2), the motor box (1) is detachably connected to the cabin cover A (2) and the rotary shaft (11); the motor box (1) is provided with a contact chip A (12), and the cabin cover A (2) is provided with a contact chip B (13), one end of the electric wire is connected with the contact chip B (13), and the other end of the electric wire is connected with the control box (8); a rechargeable battery is configured within the control box (8) and a charge socket is arranged on the control box (8); the motor box (1) can be replaced by a hand-operated rocker (21).

2. The dual-mode automobile protective cover device according to claim 1, wherein, a protective cover guard disc (3) is provided at each of the two ends of the cabin (5).

3. The dual-mode automobile protective cover device according to claim 1, wherein the motor box (1) and the cabin cover A (2) are connected by means of a snap-fit (9), a snap-in slot (14) is provided on the cabin cover A (2) and a snap-fit (9) is provided on the motor box (1), wherein the snap-fit (9) is made up of a male part (15) and a female part (16), the female part (16) is cut with a groove (22) in which a sliding bar (20) and a spring (19) are arranged; the male part (15), which is of Z shape, has a sliding slot (18) in its front end, the sliding slot (18) is in slide connection with the sliding bar (20), and a hook (17) that can be buckled with the snap-in slot (14) is arranged at the back end of the male part (15).

4. The dual-mode automobile protective cover device according to claim 3, wherein the cabin cover A (2) can be provided with two snap-in slots (14), and accordingly the motor box (1) can be provided with two snap-fits (9).

5. The dual-mode automobile protective cover device according to claim 1, wherein a contact chip A (12) is arranged on the control box (8), a contact chip B (13) is arranged on the cabin cover B (7), and the other end of the electric wire is fitly connected with the contact chip B (13).

6. The dual-mode automobile protective cover device according to claim 1, wherein, the control box (8) and the cabin cover B (7) are connected by means of a snap-fit (9), a snap-in slot (14) is arranged in the cabin cover B (7) and a snap-fit (9) is arranged on the control box (8); the snap-fit (9) is made up of a male part (15) and a female part (16); a groove, in which a sliding bar (20) and a spring (19) are arranged, is provided in the female part (16); the male part is Z-shaped, a sliding slot (18), which is in slip connection with the sliding bar (20), is arranged in the front end of the male part (15), and a hook (17), which can be buckled with the snap-in slot (14), is arranged at the back end of the male part (15).

7. The dual-mode automobile protective cover device according to claim 6, wherein the cabin cover B (7) can be configured with two snap-in slots (14), and accordingly the control box (8) can be arranged with two snap-fits (9).

8. The dual-mode automobile protective cover device according to claim 1, wherein, the control box (8) is provided with a control button and an indicator light.

9. The dual-mode automobile protective cover device according to claim 1, wherein, the cabin (5) is provided with an anti-slide mat (6), the material of which comprises sponge.

10. The dual-mode automobile protective cover device according to claim 1, wherein, the invention can be operated remotely through a remote control (23).
